(19) United States
(12) Patent Application Publication
(10) Pub. No.: US 2007/0293179 A1
(43) Pub. Date: Dec. 20, 2007

(54) Analog/digital broadcast signal receiver

(75) Inventor: Dou Yuanzhu, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD.

(21) Appl. No.: 11/807,128

(22) Filed: May 24, 2007

(30) Foreign Application Priority Data
Jun. 6, 2006 (JP) 2006-157030

(51) Int. Cl. H04H 1/00; H04B 1/18; H04B 1/16

(52) U.S. Cl. 455/280; 455/337; 455/3.02

(57) ABSTRACT

A comparator for comparing an AFC output an analog demodulation circuit with a predetermined reference voltage Vref, an OR gate to which two inputs including an output of the comparator and a channel select signal are input, and a switch for connecting a crystal oscillator of a digital demodulation circuit to the digital demodulation circuit when an output of the OR gate is “H (or 1)” are provided. When an analog broadcast signal that should be received is not normally received, the crystal oscillator of the digital demodulation circuit is connected to the digital demodulation circuit to operate the digital demodulation circuit. Then, the channel select signal is supplied to a PLL circuit of a tuner front end via the digital demodulation circuit.

### CLAIM OF PRIORITY

This application claims benefit of the Japanese Patent Application No. 2006-157030 filed on Jun. 6, 2006, which is hereby incorporated by reference.

### BACKGROUND OF THE INVENTION

1. Field of the Invention

The present invention relates to a broadcast signal receiver capable of receiving broadcast signals in which analog broadcast signals and digital broadcast signals are mixed.

2. Description of the Related Art

In a receiver for receiving broadcast signals of digital modulated waves, a tuner takes out reception channel broadcast signals from the digital modulated waves and a digital demodulator demodulates the broadcast signals. In general, an MPEG demodulation circuit is connected in a subsequent stage of the digital demodulator. The MPEG demodulation circuit generates large digital noise in order to operate a built-in CPU. There is a problem in that the digital noise generated from the MPEG demodulation circuit are placed on SCL and SDA signals of an I²C bus and intrudes into other circuits, thus causing a reception failure. For that reason, such a configuration is adopted in the digital demodulator that a filter or a buffer for removing the digital noise is provided on the I²C bus line and the SCL and SDA signals are supplied to other circuit (for example, a tuner circuit) via the filter or the buffer.

For example, in a receiver for receiving analog and digital mixed signals, it is necessary to set the digital demodulator turned ON all the time in order to supply the SCL and SDA signals to the tuner circuit via the I²C bus at the time of the reception of the analog broadcast signals as well.

However, for keeping the operation of the digital demodulator, a dedicated crystal oscillator needs to oscillate to generate clock signals at a predetermined oscillating frequency (for example, 25.14 MHz). For example, the oscillating frequency at 25.14 MHz is a frequency whose higher harmonic wave is within a reception frequency band. In particular, as its influence is large at the time of the reception of the analog broadcast, the oscillation of the crystal oscillator of the digital demodulator has to be stopped at the time of the reception of the analog broadcast.

Although channel select signals are input to the tuner circuit via the digital demodulator all the time, the update of the channel select signals, which is set in a PLL circuit of the tuner circuit, is suspended due to the operation stop of the digital demodulator. For this reason, at the time of the reception of the analog broadcast, in the tuner circuit, during the reception of a certain channel, even when the oscillation frequency is shifted on the basis of the change in the setting of the PLL circuit due to an external interference or the like (electric waves of a mobile phone, etc.), the shift cannot be corrected. Thus, such a failure occurs that a desired channel cannot be received. In order to solve this problem, a method of separately supplying the channel select signals to the PLL circuit of the tuner circuit not via the digital modulation circuit is proposed (for example, refer to Japanese Unexamined Patent Application Publication No. 2000-224061).

However, according to the method disclosed in Japanese Unexamined Patent Application Publication No. 2000-224061, as it is necessary to add a circuit for separately supplying the channel select signal for controlling the PLL circuit of the tuner circuit, such a problem is generated that the circuit scale becomes large, which leads to the increase in costs.

### SUMMARY OF THE INVENTION

Accordingly, the present invention has been made to in view of the above and provides a broadcast signal receiver capable of correcting a shift of a local oscillation frequency due to external noise at the time of the reception of the analog broadcast while suppressing the scale-up of the circuit to minimum.

A broadcast signal receiver according to an aspect of the present invention includes a frequency conversion circuit for receiving broadcast signals in which an analog broadcast signal and a digital broadcast signal are mixed and for performing a frequency conversion into one of an analog intermediate frequency and a digital intermediate frequency whose frequency is set in accordance with a control signal that is supplied to a built-in PLL circuit; an analog signal demodulation circuit for demodulating the analog broadcast signal of the analog broadcast signal output from the frequency conversion circuit; a digital demodulation circuit having a signal transmission line that supplies the control signal to the PLL circuit passing therein and is connected to the PLL circuit, for attenuating noise on the signal transmission line and for demodulating the digital broadcast signal of the digital intermediate frequency output from the frequency conversion circuit; a clock signal generation circuit for generating a clock signal that causes the digital demodulation circuit to operate; and a control circuit for stopping supply of the clock signal with use of a signal from an outside at a time of reception of the analog broadcast, for determining whether or not the analog broadcast signal is normally received on the basis of an operation state of the analog signal demodulation circuit in a state where an operation of the digital demodulation circuit is stopped, and for supplying the clock signal to the digital demodulation circuit when the analog broadcast signal is not normally received to supply the control signal to the PLL circuit.

According to this configuration, the control signal is supplied via the digital demodulation circuit to the PLL circuit for controlling the reception frequency of the frequency conversion circuit, and at the time of the reception of the analog broadcast, the operation of the digital demodulation circuit is stopped and the noise generated in the subsequent stage of the digital demodulation circuit is prevented from intruding into the PLL circuit via the signal transmission line. On the other hand, when the analog broadcast signal is not normally received at the time of the reception of the analog broadcast, the clock signal generated in the clock signal generation circuit is supplied to the digital signal demodulation circuit for operation. Thus, the communication based on the signal transmission line via the digital demodulation circuit can be performed, and it is possible to supply the control signal to the PLL circuit. Therefore, at the time of reception of the analog broadcast signal, even when the shift of the local oscillation frequency is caused in the frequency conversion circuit due to the external interference such as the electric waves of the mobile phone, the shift can be corrected immediately.

According to a further aspect of the present invention, in the broadcast signal receiver, the control circuit uses an AFC (Automatic Frequency Control) signal as a signal that indicates the operation state of the analog signal demodulation circuit and determines whether or not the analog broadcast signal is normally received on the basis of a comparison result after comparing an output level of the AFC signal with a reference value.

With this configuration, the analog broadcast signal is not input to the analog signal demodulation circuit. In a case where the digital broadcast signal or a signal outside the band of the broadcast signal (noise or the like) is input, the AFC signal is set to have a specific voltage value. Thus, on the basis of the comparison result between the AFC signal and the reference value, it is possible to detect the state where the analog broadcast signal is not normally received, and if the analog broadcast signal is not normally received, the normal reception can be immediately achieved again.

In addition, according to a further aspect of the present invention, in the broadcast signal receiver, the signal transmission line passing through the digital demodulation circuit is composed of the I²C bus, the PLL circuit is connected to the I²C bus on a side of the frequency conversion circuit, and an MPEG circuit for decoding a demodulation digital signal is connected to the I²C bus on a side opposite to the frequency conversion circuit.

According to the present invention, while the scale-up of the circuit to minimum is suppressed, it is possible to correct the shift of the oscillation frequency due to the external noise at the time of reception of the analog broadcast signal.

### BRIEF DESCRIPTION OF THE DRAWINGS

FIG. 1 is a block diagram illustrating a schematic configuration of a digital/analog signal receiver according to an embodiment of the present invention;

FIG. 2 is a block diagram illustrating a schematic configuration of a tuner front end; and

FIG. 3 is an explanatory diagram for illustrating an operation of the digital/analog signal receiver according to the embodiment.

### DESCRIPTION OF THE PREFERRED EMBODIMENTS

Hereinafter, embodiments of the present invention will be described with reference to the attached drawings.

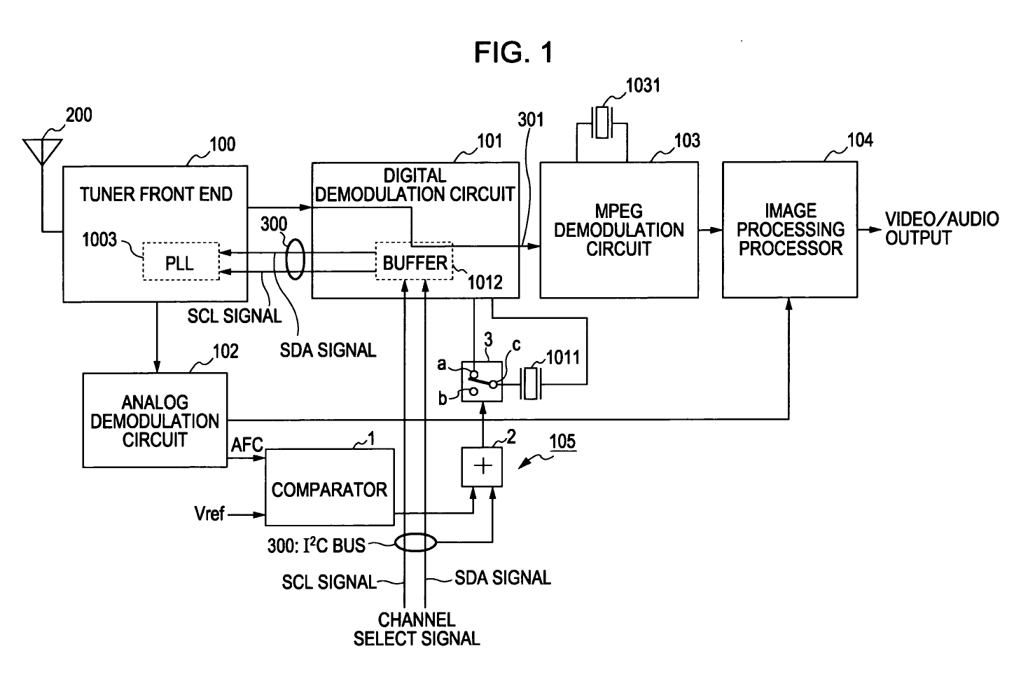

FIG. 1 a block diagram illustrating a schematic configuration of a digital/analog signal receiver according to an embodiment of the present invention. The broadcast signal receiver according to the embodiment is composed of a tuner front end 100, a digital demodulation circuit 101, an analog demodulation circuit 102, and a clock supply control circuit 105. An MPEG demodulation circuit 103 and an image processing processor 104 are provided in a subsequent stage of the digital demodulation circuit 101.

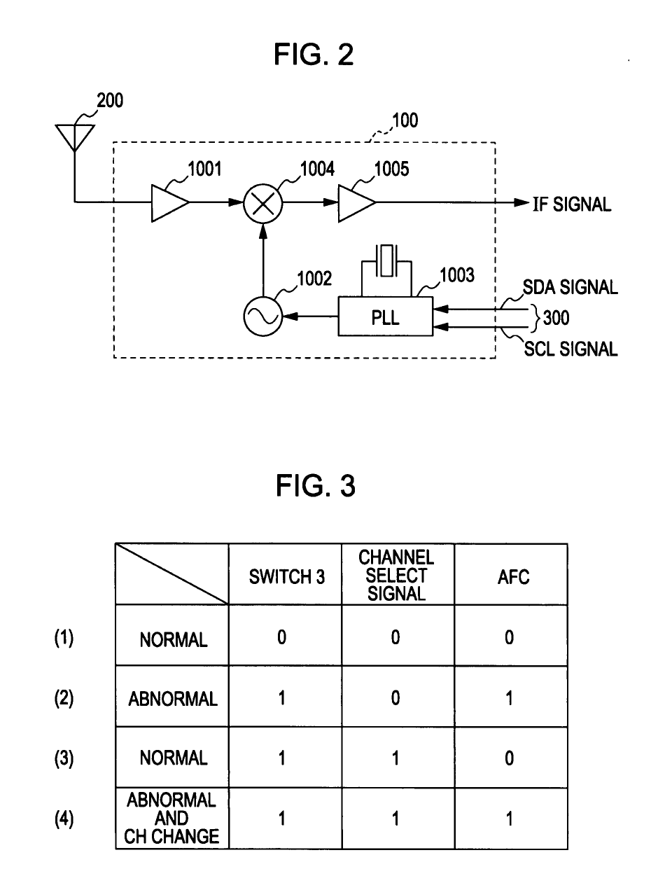

FIG. 2 is a block diagram illustrating a detailed configuration of the tuner front end 100. As shown in this drawing, broadcast signals input an antenna 200 (broadcast signals in which analog modulated waves and digital modulated waves are mixed) are amplified by a high frequency amplifier 1001 and input to a mixer 1004. On the other hand, channel select signals (SDA signal, SCL signal) which are sent on an I²C bus 300 functioning as a signal transmission line are input to a PLL (Phase Locked Loop) circuit 1003. The PLL circuit 1003 applies a local oscillator 1002 with a control signal corresponding to the channel select signal and inputs a local oscillation signal of an oscillation frequency corresponding to a reception channel to the mixer 1004. The mixer 1004 uses the local oscillation signal from the local oscillator 1002 to convert the reception broadcast signal into the intermediate frequency signal. An intermediate frequency amplifier 1005 amplifies the intermediate frequency signal from the mixer 1004 to be output to the digital demodulation circuit 101 and the analog demodulation circuit 102.

The digital demodulation circuit 101 is operated in accordance with a clock signal at an oscillation frequency of 25.14 MHz which is generated at a crystal oscillator 1011. The digital demodulation circuit 101 digitally demodulates the intermediate frequency signal of the received channel and obtains a digital signal (TS: transport stream). Then, the digital signal (TS) is input via an I²C bus 301 to an MPEG (Moving Picture Experts Group) demodulation circuit 103. The I²C bus 300 for the channel select signal is connected to the digital demodulation circuit 101. The channel select signal send on the I²C bus 300 is input via the digital demodulation circuit 101 to a PLL circuit 1013 of the tuner front end 100.

In the digital demodulation circuit 101, in order that the digital noise generated at the MPEG demodulation circuit 103 is not placed on the channel select signal of the I²C bus 300, a buffer 1012 is provided for removing the digital noise. The digital noise generated at the MPEG demodulation circuit 103 is noise at an extremely large level, and if this noise is placed on the channel select signal, an output of the PLL circuit 1003 varies, for instance, an analog channel is shifted to a digital channel or is deviated from the broadcast signal band, whereby a severe reception failure is caused. It should be noted that a filter can be used instead of the buffer 1012, and as long as the noise can be attenuated, other configurations may be adopted.

The MPEG demodulation circuit 103 is operated in accordance with a clock signal generated at a crystal oscillator 1031. The MPEG demodulation circuit 103 performs an MPEG demodulation to obtain video data and audio data. The image processing processor 104 generates a video signal for monitor display from the video data obtained at the MPEG demodulation circuit 103 and also generates an analog audio signal from the audio data for output.

The analog demodulation circuit 102 demodulates the intermediate wave of the analog modulated wave from the tuner front end 100. The modulation signal from the analog demodulation circuit 102 is input to the image processing processor 104 to generate a video signal for monitor display and also output an audio signal.

According to the embodiment, the clock supply control circuit 105 is provided for controlling the operation of the crystal oscillator 1011 of the digital demodulation circuit 101. In a case where an IF signal output from the tuner front end 100 at the time of the reception of the analog broadcast is shifted to the digital channel side or is deviated from the broadcast signal band (put into a state where there is no input of broadcast signal), the crystal oscillator 1011 is turned ON so that the channel select signal is input via the digital demodulation circuit 101 to the PLL circuit 1003 of the tuner front end 100.

The clock supply control circuit 105 is composed of a comparator 1 for comparing an AFC (Automatic Frequency Control) output of the analog demodulation circuit 102 and a predetermined reference voltage Veer (for example, 4 V), an OR gate (OR circuit) 2 for two inputs to which an output of the comparator 1 and the channel select signal are input, and a switch 3 for connecting when the crystal oscillator 1011 of the digital demodulation circuit 101 to the digital demodulation circuit 101 an output of the OR gate 2 is “H (or 1)”.

When the analog broadcast signal is input to the analog demodulation circuit 102, the AFC output is stabled at, for example, about 2.5 V. When the digital signal is input to the analog demodulation circuit 102 or when the analog signal or the digital signal is not input, the AFC output is fixed at, for example, about 5 V. In view of the above, such a configuration is adopted that while the reference voltage Vref given to the comparator 1 is set to 4 V and if the AFC output exceeds 4 V of the reference voltage Vref, the output of the comparator 1 becomes “H (or 1)”. In a case where the output value of the PLL circuit 1003 in the tuner front end 100 is returned to the original value and the analog signal is input to the analog demodulation circuit 102, when the AFC output is equal to or smaller than 4 V of the reference voltage Vref, the output of the comparator 1 becomes “L (or 0)”. When the output of the comparator 1 is “H (or 1)”, the output of the OR gate 2 becomes “H (or 1)”. It should be noted that the reference voltage Vref of the comparator 1 is desirably about 4 V in a case of using the AFC output. If an output other than the AFC output is used, a desirable value is appropriately set with which it is possible to determine whether or not the analog signal is input to the analog demodulation circuit 102.

When a contact a and a contact c are connected to each other by way of the switch 3, the crystal oscillator 1011 is connected to the digital demodulation circuit 101, whereby the digital demodulation circuit 101 is put into an operatable state in accordance with the clock signal of the crystal oscillator 1011. Then, when the contact c is connected on a contact b side by way of the switch 3, the clock signal of the crystal oscillator 1011 is not supplied to the digital demodulation circuit 101 to achieve a stopped state. The common contact c of the switch 3 is usually located on the contact b side and is switched on the contact a side when the output of the OR gate 2 is “H (or 1)”. This state is continued as long as the output of the OR gate 2 is “H (or 1)”. As the common contact c of the switch 3 is switched on the contact a side, one end of the crystal oscillator 1011 is connected to the digital demodulation circuit 101, whereby the digital demodulation circuit 101 starts operating in accordance with the clock signal of the crystal oscillator 1011. As a result, the communication based on the I²C bus 300 is enabled, and the channel select signal (SDA signal, SCL signal) is supplied via the digital demodulation circuit 101 to the PLL circuit 1003 of the tuner front end 100. Therefore, even when the external interference such as the electric waves of the mobile phone causes the reception failure to change the output value of the PLL circuit 1003 of the tuner front end 100 and the local oscillation frequency is changed, the communication based on the I²C bus 300 for transmitting the channel select signal is enabled. Thus, the output value of the PLL circuit 1003 of the tuner front end 100 is corrected and the local oscillation frequency is returned to the original value.

In addition to the output of the comparator 1, a control signal is input to the OR gate 2 from a control circuit not shown in the drawing. As the control signal is input to the OR gate 2, the output of the OR gate 2 becomes “H (or 1)”. In this case as well, the communication based on the I²C bus 300 is enabled, and the channel select signals (SDA signal, SCL signal) are supplied via the digital demodulation circuit 101 to the PLL circuit 1003 of the tuner front end 100. Therefore, at the time of reception of the analog broadcast signal too, it is possible to cope with the channel select operation with use of a remote controller or the like, and at the time of reception of the analog broadcast signal, other channel select signal can be supplied to the PLL circuit 1003, thus setting the objective reception channel.

Next, a description will be given of an operation of the thus configured receiver according to the embodiment.

At the time of reception of the analog broadcast signal, with use of the control signal input from a channel selection circuit to the OR gate 2, the crystal oscillator 1011 is connected to the digital demodulation circuit 101, and a new channel select signal of the analog channel is supplied via the digital demodulation circuit 101 to the PLL circuit 1003. If the channel select signal has no channel change, the channel select signal is kept as it is without change. The switch 3 connects the contact c on the contact b side after an elapse of a sufficient time during which the new channel select signal of the analog channel is supplied to the PLL circuit 1003 with use of the control signal via the OR gate 2 to stop the operation of the digital demodulation circuit 101.

In the tuner front end 100, in response to the control signal output from the PLL circuit 1003, the oscillation frequency for receiving the reception channel of the analog channel from the local oscillator 1002. The intermediate frequency signal of the analog modulated wave from the tuner front end 100 is input to the analog demodulation circuit 102 to demodulate the video signal and the audio signal. Then, the video signal and the audio signal thus demodulated are input to the image processing processor 104 to generate the video signal for the monitor display and to output the audio signal. In this way, at the time of the reception of the analog broadcast, the operation of the digital demodulation circuit 101 is stopped after the reception channel setting. Therefore, it is possible to reliably prevent such a phenomenon from occurring that the noise generated at the digital demodulation circuit 101 intrudes into the PLL circuit 1003 via the I²C bus 300 to change the setting.

On the other hand, at the time of the reception of the digital broadcast signal, the new control signal input from the control circuit to the OR gate 2 connects the crystal oscillator 1011 to the digital demodulation circuit 101. The new channel select signal of the digital channel is supplied to the PLL circuit 1003 via the digital demodulation circuit 101. At the time of the reception of the digital broadcast signal, as the digital signal is input to the analog demodulation circuit 102, the AFC output is fixed to 5 V. Therefore, as different from the time of the reception of the analog broadcast, “H (or 1)” is continuously output to the OR gate 2, and the switch 3 connects the common contact c on the contact a side so that the digital demodulation circuit 101 can be continuously operated.

In the tuner front end 100, the oscillation frequency is generated for receiving the reception channel of the digital channel from the local oscillator 1002. The intermediate frequency signal of the digital modulated wave from the tuner front end 100 is input to the digital demodulation circuit 101, thus obtaining the digital signal. Then, the video data, the audio data, and the like are separated from the thus obtained digital signal. After that, the video data and the audio data which are MPEG-demodulated are obtained and input to the image processing processor 104. Thus, the video signal for the monitor display is generated and also the audio signal is output.

Here, referring to FIG. 3, a description will be given of a detail of a switching operation in the switch 3. FIG. 3 is a table summarizing the states of the switch 3 depending on an input state of the channel select signal and an output state of the AFC. In this drawing, a state where the channel select signal from the channel selection circuit is changed is represented by “1”, and a state where the channel select signal from the channel selection circuit is not changed is represented by “0”. Also, a comparator output when the AFC output is normal is represented by “0”, and a comparator output when the AFC output is abnormal is represented by “1”. Moreover, a state where the common contact c of the switch 3 is switched to the contact a side is represented by “1”, and a state where the common contact c of the switch 3 is on the contact b side is represented by “0”.

(1) When the AFC output is normal and the channel select signal is not changed, the control of the PLL circuit 1003 is unnecessary. In such a state, as long as the control signal is not supplied from the outside, the common contact c of the switch 3 is maintained on the contact b side.

(2) When the AFC output is abnormal and the channel select signal is not changed, the output value of the PLL circuit 1003 of the tuner front end 100 is changed. In such a state, the common contact c of the switch 3 is switched on the contact a side and the channel select signal is supplied to the PLL circuit 1003.

(3) When the AFC output is normal and the channel select signal is changed and a channel selection is newly performed, the common contact c of the switch 3 is switched on the contact a side and the new channel select signal is supplied to the PLL circuit 1003.

(4) When the AFC output is abnormal and also the channel select signal is changed, even in the channel select state, the output value of the PLL circuit 1003 of the tuner front end 100 is changed. In such a state, the common contact c of the switch 3 is switched on the contact a side and the new channel select signal is supplied to the PLL circuit 1003.

In this manner, according to the embodiment, on the basis of the AFC output value of the tuner front end 100, it is determined as to whether or not the reception of the analog broadcast signal is normally performed. In a case where the normal reception is not performed, the crystal oscillator 1011 is connected to the digital demodulation circuit 101 to temporarily enable the communication based on the I²C bus 300. Then, the channel select signal is supplied to the PLL circuit 1003 of the tuner front end 100 to correct the output value. As a result, even when the external interference such as the electric waves of the mobile phone at the time of reception of the analog broadcast signal changes the output value of the PLL circuit 1003 of the tuner front end 100 to change the local oscillation frequency, the immediate correction can be made. Also, the comparator 1, the OR gate 2, and the switch 3 are added, but it is unnecessary to provide means for separately supplying the channel select signal with which the PLL circuit 1003 of the tuner front end 100 is controlled. Therefore, the scale-up of the circuit can be suppressed to minimum and accordingly the cost up can be suppressed to minimum.

It should be noted that according to the above-mentioned embodiment, the AFC output is used for determining whether or not the reception of the analog broadcast signal is normally performed, but other parameter can also be used as long as at least the state where the analog broadcast signal is normally received and another states (where the digital broadcast signal is received or where the signal out of the band is received) can be distinguished from each other. For example, the video output of the analog demodulation circuit 102 may be used.

Also, the switch control is described in the above-mentioned embodiment for the control of the crystal oscillation circuit, but means for directly controlling the power supply of the oscillation circuit or the like may be used.

In addition, according to the above-mentioned embodiment, the clock supply control circuit 105 is realized by using the comparator 1, the OR gate 2, and the switch 3, but it is also possible to use micro computers for the comparator 1 and the OR gate 2 instead.

The present invention can be applied to a television receiver, a recorder with a built-in tuner, a mobile phone, and the like, which are capable of receiving broadcast signals in which the analog broadcast signal and the digital broadcast signal are mixed.

What is claimed is:

1. A broadcast signal receiver, comprising:
a frequency conversion circuit for receiving broadcast signals in which an analog broadcast signal and a digital broadcast signal are mixed and for performing a frequency conversion into one of an analog intermediate frequency and a digital intermediate frequency whose frequency is set in accordance with a control signal that is supplied to a built-in PLL circuit;
an analog signal demodulation circuit for demodulating the analog broadcast signal of the analog broadcast signal output from the frequency conversion circuit;
a digital demodulation circuit having a signal transmission line that supplies the control signal to the PLL circuit passing therein and is connected to the PLL circuit, for attenuating noise on the signal transmission line and for demodulating the digital broadcast signal of the digital intermediate frequency output from the frequency conversion circuit;
a clock signal generation circuit for generating a clock signal that causes the digital demodulation circuit to operate; and
a control circuit for stopping supply of the clock signal with use of a signal from an outside at a time of reception of the analog broadcast, for determining whether or not the analog broadcast signal is normally received on the basis of an operation state of the analog signal demodulation circuit in a state where an operation of the digital demodulation circuit is stopped, and for supplying the clock signal to the digital demodulation circuit when the analog broadcast signal is not normally received to supply the control signal to the PLL circuit.

2. The broadcast signal receiver according to claim 1, wherein the control circuit uses an AFC (Automatic Frequency Control) signal as a signal that indicates the operation state of the analog signal demodulation circuit and determines whether or not the analog broadcast signal is normally received on the basis of a comparison result after comparing an output level of the AFC signal with a reference value.

3. The broadcast signal receiver according to claim 1, wherein the signal transmission line passing through the digital demodulation circuit is composed of an I²C bus, the PLL circuit is connected to the I²C bus on a side of the frequency conversion circuit, and an MPEG circuit for decoding a demodulation digital signal is connected to the I²C bus on a side opposite to the frequency conversion circuit.
